(19) United States
(12) Patent Application Publication
(10) Pub. No.: US 2006/0289276 A1
(43) Pub. Date: Dec. 28, 2006

(54) Automatic recycling device for empty containers, cleaning module, and method for operation of the automatic recycling device

(76) Inventors: Siegmar Hecht, Ilmenau (DE); Johann Loning, Oldenburg (DE)

Correspondence Address: SHLESINGER, ARKWRIGHT & GARVEY LLP, Suite 600, 1420 King Street, Alexandria, VA, 22314, US

(21) Appl. No.: 11/398,758

(22) Filed: Apr. 6, 2006

Related U.S. Application Data
(63) Continuation of application No. PCT/DE04/02298, filed on Oct. 12, 2004.

(30) Foreign Application Priority Data
Oct. 14, 2003 (DE) 103 47 565.6

(51) Int. Cl. B65G 45/22

(52) U.S. Cl. 198/495

(57) ABSTRACT

Automatic recycling device for empty containers, in particular bottles, cans, and the like, includes a cleaning device, a recognition unit, an introduction unit for the empty containers, at least one transport run, defined by a conveyor belt. Cleaning module and a method for operation of the automatic recycling device in a cleaning mode is likewise provided. Automatic or semi-automatic cleaning of at least one transport run of the automatic recycling machine is provided without installation of stationary cleaning devices. A separate cleaning module is provided that is insertable into the automated device, and which may be transported through the automated device by the conveyor belt. A stop holds the cleaning module stationary as conveyor belt runs, and cleaning fluid escaping from the cleaning module is dosed onto the conveyor belt. Thorough cleaning of conveyor belt and peripheral components is achieved thanks to foam formation and the wiping effect.

### CROSS-REFERENCE TO RELATED APPLICATIONS

This application is a continuation of application no. PCT/DE2004/002298, filed Oct. 12, 2004, which claims the priority of German application no. 103 47 565.6, filed 14 Oct. 2003, and each of which is incorporated herein by reference.

### FIELD OF THE INVENTION

The present invention relates to a reverse vending machine. More particularly, the invention relates to a reverse vending machine including a cleaning module, as well as a procedure for operating the reverse vending machine in a cleaning mode.

### BACKGROUND OF THE INVENTION

Reverse vending machines are known from, for example, the following publications: WO 93/25981, EP 0561148 B1, DE 43 18 388, DE 44 43 406, DE 36 05 921, DE 196 13 099 A1, DE 37 15 815 A1, U.S. Pat. No. 5,085,308, EP 0 612 046 A1, WO 93/03460, DE 93 21 439 U1, GB 1 552 927, DE-Gbm 73 12 603. These automats or automated machines are mainly used in large markets, shopping malls or beverage markets, and enable automatic redemption of empties such as bottles, cans, cups, etc.

There are transport routes in reverse vending machines on which the empties are handled by the automated device. As a rule, these transport routes are conveyor belts.

Since the empties typically contain residual fluid that can exit during handling in the reverse vending machine, severe contamination of the transport routes occurs after a certain period of operation, and also occurs in other units, and such impairs the operability of the automatic or automated device. According to the present state of the art, reverse vending machines are therefore manually cleaned at specific intervals. That is very expensive and, given the cramped space situations in the automatic device, also difficult, so that the quality of the cleaning suffers from it. Moreover, damage to automated device installations can occur from this cleaning activity.

From EP 1 150 257 A1 a reverse vending machine for empties is already known, that has at least one entry unit, one recognition unit, and one output unit, as well as units which connect transport routes. At least one of these units and/or at least one of the transport routes is equipped with cleaning facilities for self-cleaning. Optimal and effective cleaning of the reverse vending machine is possible with it. Damage, as is possible from manual cleaning, is also avoided by this solution. Moreover, man hours are saved since the reverse vending machine, so to speak, cleans itself. The cleaning device is fixedly built-in in this reverse vending machine.

As to the state of the art, there are, furthermore, conveyor belt cleaning installations as, for example, those described in U.S. Pat. No. 5,355,992, U.S. Pat. No. 5,613,594, U.S. Pat. No. 5,372,243, U.S. Pat. No. 5,649,616, U.S. Pat. No. 6,244,423 B1, U.S. Pat. No. 4,860,883, U.S. Pat. No. 5,598,915, and U.S. Pat. No. 4,960,200. These appliances, too, are stationary, i.e. solidly built-in facilities.

### OBJECTS AND SUMMARY OF THE INVENTION

An object of the present invention is to make a solution available that enables automatic as well as semi-automatic cleaning of at least one conveyor section without installing stationary cleaning devices.

This object is solved in accordance with the invention with a reverse vending machine for empties including a cleaning device, a recognition unit, an entry unit for the empties, a conveyor belt, and the cleaning device including a separate cleaning module insertable into the entry unit. Further, the cleaning module is conveyable through the automated device via the conveyor belt. The cleaning module may include a hollow body fillable with cleaning fluid, and a contact surface configured for resting on a transport surface of the conveyor belt. The wall of the cleaning module may be perforated in a region of its contact surface, and through which a cleaning fluid exits, in use. Also, one of the reverse vending machine and the cleaning module may include a stop configured for stopping the cleaning module in a substantially stationary position on the conveyor belt when the conveyor belt is moving.

A cleaning module, and a method of operating the reverse vending machine with the inventive insertable cleaning module are likewise provided in accordance with the invention.

In the device according to the invention, the cleaning device is not built-in and stationary in the reverse vending machine, but is a separate module, which is like that of a reverse vending machine receiving empties via its entry unit in which insertion is possible.

With insertion of the cleaning module in reverse vending machines, such runs in a cleaning mode. In this mode, stopping mechanisms of the automated device and/or of the cleaning module are activated so that the cleaning module is substantially kept in place by the latter with the running conveyor belt. These stop mechanisms can, for example, be of a mechanical, electromechanical, or electromagnetic type. They cause the cleaning module to not be further advanced on the conveyor belt when it is running.

The cleaning module is a hollow body filled with cleaning liquid that can be applied to the transport surface of the conveyor belt having at least one supporting surface. Its at least one supporting surface is adjusted to the shape of the transport surface of the conveyor belt, so that with its at least one supporting surface it substantially lies flat on the transport surface. The wall of the cleaning module is perforated in the region of its contact surface. The cleaning medium exits through these perforations and moistens the conveyor. Given the relative movement between the conveyor belt and the cleaning module, foam formation occurs that moistens not only the transportation surface of the conveyer belt but also the pulleys of the conveyor belt and additional elements and devices in proximity to the conveyor belt. It has been found that this foam formation and the interplay with the mopping effect between the transportation surface of the conveyor belt and the contact surface of the cleaning module yield a good cleaning effect.

This cleaning effect is substantially improved if the at least one supporting surface of the cleaning module includes a coating which receives the cleaning fluid and passes it to the transportation surface of the conveyor belt. Thereby a better distribution of the cleaning medium takes place on the transportation surface of the conveyor belt and foam formation is intensified. The coating can, for example, include webbing or microfiber tissue, so that sufficient wetting of the tissue is achieved, the perforations are advantageously constructed as through holes, whereby these through holes are expediently configured as bores.

The cleaning mode of the reverse vending machine can be switched on manually or automatically. For automatic switching on of the cleaning mode, the recognition units, which are in place in the reverse vending machine anyway, are used. This can, for example, be handled by barcode readers or cameras. So that the cleaning module can be recognized by the recognition units as such, it is therefore equipped with barcodes, transponders, surface profilers, etc. The cleaning module, in particular, can however also be recognized by the camera on the basis of its configuration. If the presence of the cleaning module is recognized in the automated device via the recognition units, then the stop mechanisms are activated by a controller so that further transport/insertion of the cleaning mode on the conveyor belt is not possible for a preset time, despite a running conveyor belt. The cleaning module can, however, also include stop mechanisms such as a rod that strikes a sheet of metal situated in the automated device, so that the further transportation of the cleaning module is prevented and the conveyor belts can be cleaned.

Further advantageous embodiments of the invention are explained in more detail below.

Relative terms such as left, right, up, and down are for convenience only and are not intended to be limiting.

### BRIEF DESCRIPTION OF THE DRAWINGS

FIG. 1 is a reverse vending machine according to the invention for empties, and that includes an insertable cleaning module;

FIG. 2 is an embodiment of the cleaning module according to the invention;

FIG. 3 is an embodiment of the cleaning module according to the invention lying on the transport surface of a conveyor belt of the reverse vending machine with an activated stop mechanism;

FIG. 4 is another embodiment of the cleaning module according to the invention; and

FIG. 5 shows individual components of the cleaning module embodiment of FIG. 4.

### DETAILED DESCRIPTION OF THE INVENTION

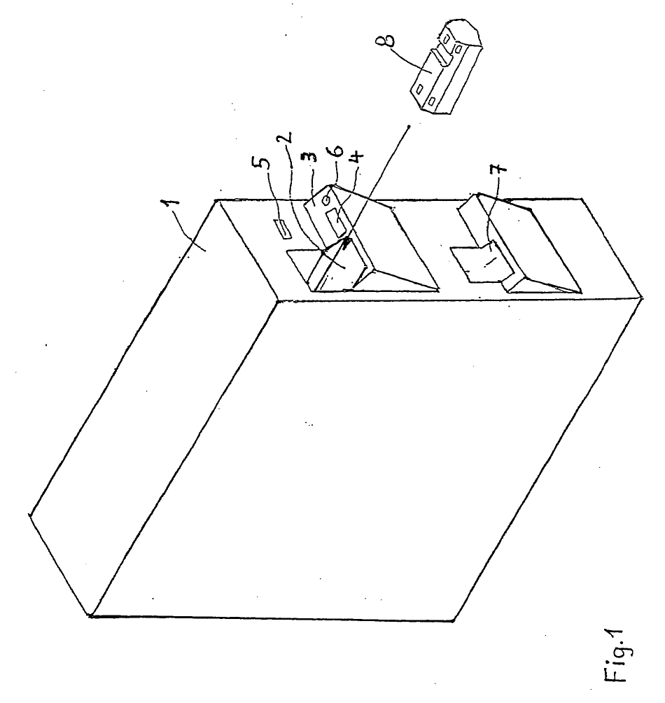

A reverse vending machine according to the invention shown in FIG. 1 includes a housing 1 with an entry opening 2 in which may be inserted empties that are to be taken back, for example, bottles or cans. The reverse vending machine furthermore includes a control console 3 with a display 4, a voucher printer 5 and a service button 6. Below the entry opening 2, there is a return opening 7 by which non-accepted empties are to be returned to a customer.

A cleaning module 8 is insertable into the reverse vending machine via the entry opening 2, as is indicated in FIG. 1. The cleaning module 8 in this embodiment includes a hollow body with a lockable filling opening 9 for a cleaning fluid. It includes two contact surfaces 10 which configured for contacting transportation surfaces 11 of a conveyor belt 12. The conveyer belt 12 is arranged in the reverse vending machine and normally serves to transport the empties that are introduced. In this embodiment, it is constructed from two conveyer belts that are placed diagonally to each other, by which a V-shaped conveyor groove is constructed. Contact surfaces 10 of the cleaning module are fitted to this V-shape of the transportation surfaces of the conveyor belt 12. They lie flat on the transportation surfaces 11, as best seen in FIG. 3. Of course, the cleaning module 8 can also be produced with other contact surfaces 10 and/or another contact surface 10 configured to the respective shape of the transport surface of the conveyor belt 12.

Contact surfaces 10 of cleaning module 8 are coated with a microfiber tissue and/or netting. Below this coating, the wall of the cleaning module 8 is perforated. These perforations, which are not obvious from the representation, are in the front as well as upper area of the cleaning module 8, i.e. provided in the region of the contact surfaces that are close to the filling opening 9. This arrangement of the perforations is necessary so that the cleaning fluid does not run out when the cleaning module 8 is stored in an upright position. It is therefore obvious that with vertical storage the maximum level of cleaning fluid in the cleaning module 8 is to be below the perforation(s).

For cleaning of the conveyor route of the reverse vending machine, it is switched into the cleaning mode. This can take place manually, if, for example, one of the service buttons that is inaccessible to customers is operated. Upon activation of this service button a locking bolt 14 is driven into the conveying path of the conveyor belt 12, and which is, for example, moved by a linear drive 15 into this position, as may be appreciated from FIG. 3. The input cleaning module 8 then runs via the entry opening 2, facilitated by the conveyor belt 12 running in the direction of the arrows 16 against the stop bolt 14 so that the cleaning module 8 comes to a stationary stop on conveyor belt 12, which goes through under the cleaning module 8. Thereby, there is a mopping contact between the contact surfaces 10 of the cleaning module 8 and the transport surfaces 11 of the conveyor belt 12. Simultaneously, cleaning fluid leaves cleaning module 8 through the perforations and that is distributed by the microfiber coating 13. A foaming formation occurs on the basis of the mopping contact. The foaming is further transported by conveyor belt 12 so that it not only covers the transport surfaces 11 of the conveyor belt 12, but also its undersides as well as the pulley shaft 17. The cleaning of the stretch of conveyor is to be kept up until the desired cleaning effect is achieved. The cleaning time can be defaulted by, for example, a timer circuit. After expiration of this cleaning period, the linear drive 15 drives the bolt 14 out of the conveyor path of the conveyor belt 12, so that the cleaning module 8 is conveyed out of the reverse vending machine or onto a connecting conveyor belt 12. In the latter case, a bolt 14 is also retracted in the conveyor path of the connecting conveyor belt 12, which then holds the cleaning module 8 on this conveyer belt 12 in a stationary position. The same procedures then play out as depicted above. After expiration of the preset cleaning time, bolt 14 is then brought out of the conveyor path of the conveyor belt 12 and the cleaning module 8 is turned off vertically by a switch on an empties collecting table.

Instead of a manual switching of the reverse vending machine into the cleaning mode, this switching on can also take place automatically. For this, the recognition unit that is already integrated into the automated device is used anyway. For releasing the automatic cleaning mode, the cleaning module 8 is inserted into the entry opening 2 of the reverse vending machine 1. The conveyor belt 12 then conveys the cleaning module 8 to the recognition unit 18. Via the recognition unit 18, the system automatically recognizes whether the object which has entered is a cleaning module 8 or an empty. This recognition can take place by means of a barcode reader 18.1, for example, that detects appropriate barcodes 19 on the cleaning module 8 or, however, by a camera 18.2, by which particular characteristics, for example, a specific gap 20 of the cleaning module 8, are detected. If the system has recognized the entered object as a cleaning module 8, then the bolt 14 is, for example, once again extended, whereby the conveyor belt 12 keeps on running.

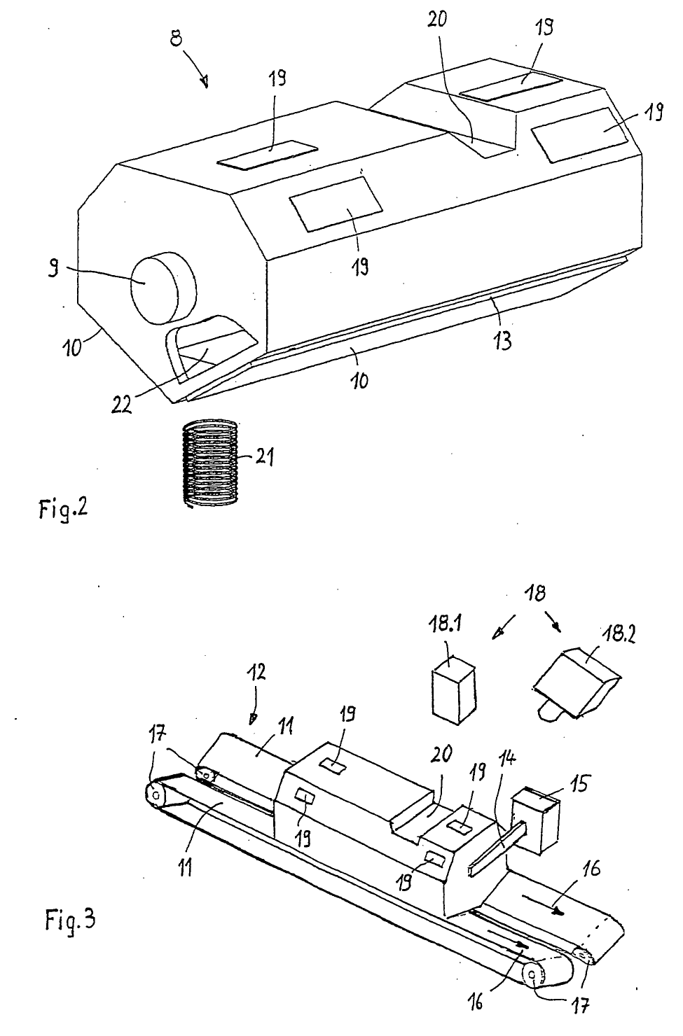

Also, an electromagnet 21 below the conveyor belt 12 can be designated as a stop mechanism for the cleaning module 8 instead of the bolt 14. This electromagnet 21 is indicated in FIG. 2 by a spool 21. In this case, a magnetic body 22 is arranged in cleaning module 8, as it emerges as shown in FIG. 2, in which for visualization of the magnetic body 22 the upper side of the cleaning module 8 is accordingly displayed as broken away. The stationary stopping of the cleaning module 8 via an electromagnet 21 can, of course, also be provided by a manually started cleaning mode.

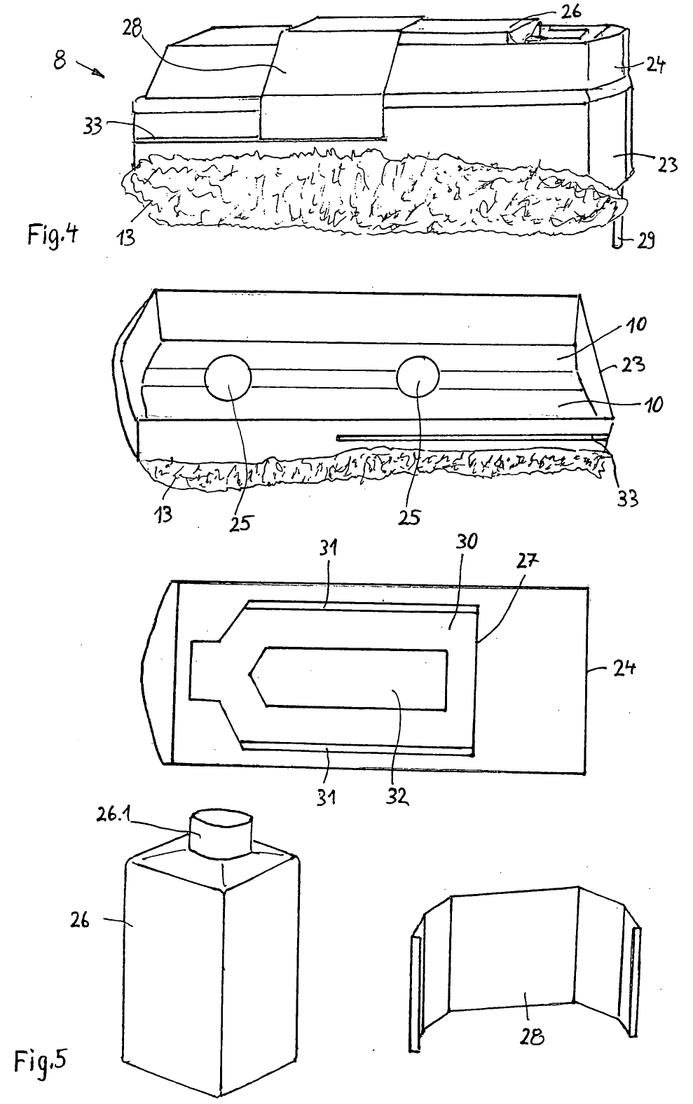

In FIGS. 4 and 5, a second preferred embodiment of a cleaning module 8 is represented. This cleaning module 8 includes a base 23 constructed as tub-shaped and a top 24 constructed as a cover. The base 23 and the top 24 are connectable together as interlocking parts. This base 23 shows openings or breakthroughs 25 constructed as bores on the contact surfaces 10. The contact surfaces 10 conform, moreover, to the V-shape of the transport surfaces 11 of the conveyor belt. The contact surfaces 10 are coated with a microfiber tissue 13. The cleaning fluid is filled in the cleaning module 8 by a separate bottle 26 that is insertable into a notch 27 provided in the top 24 that fits the contour of the bottle 26, as emerges from the top view representation of the top 24 according to FIG. 5 and from FIG. 4. The bottle 26 is not lying directly on a base 30 of the top 24, but is distanced from it. Clearance ledges 31 that protrude from the base 30 take care of this and bottle 26 lies lengthwise thereon. The clearance ledges 31 are implemented slantwise, so that the bottle 26 lies inclined, and when cover 26.1 is opened the cleaning fluid can run out. It first reaches an opening 32 provided in the base 30 of the top 24 and from there through the breakthroughs 25 into the microfiber coating 13. The bottle 26 can even be secured with an additional clamping bracket 28 that is pushed in by its edges into the longitudinal grooves 33 provided in the base 23 and lies on the bottle 26 from above.

The cleaning module 8 is only filled in this embodiment before the cleaning application with the fluid, inasmuch as the opened bottle 26 is inserted so that the breakthroughs 25 can guarantee a quick and effective wetting of the microfiber tissue 13 with the cleaning fluid. Since the cleaning module 8 is not stored with filled cleaning fluid and/or an inserted closed bottle 26, there is no danger of cleaning fluid escaping out through breakthroughs 25 during storage of the cleaning module 8.

For cleaning of the conveyor route of the reverse vending machine, cleaning module 8 is inserted into the reverse vending machine. The camera 18.2 recognizes the contour of the cleaning module 8 and can therefore automatically shift into the cleaning mode of the automated device. The cleaning module 8 is equipped with a stop stick 29, which, upon transportation of the cleaning module 8 on the conveyer belts 12, drives against a stop arranged in the reverse vending machine that is, for example, constructed as a cover plate, and blocks the further conduct of the module 8. Since the conveyor belt 12 keeps on running then, as in the first implementation example, a cleaning effect is generated by the mopping contact between the microfiber coating 13 of the transportation surface 11 of the conveyor belt 12. Via the enlarged perforations 25, the cleaning fluid can exit the module 8 faster and moisten the microfiber tissue 13, so that the conveyor belt 12 can become more efficiently foamed up throughout with the cleaning fluid. This leads to a shorter cleaning period and improved cleaning of the conveyor belt 12.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. Reverse vending machine for empties, comprising:
a) a cleaning device;
b) a recognition unit;
c) an entry unit for the empties;
d) a conveyor belt;
e) the cleaning device including a separate cleaning module which is insertable into the entry unit, and being conveyable through the automated device via the conveyor belt;
f) the cleaning module including a hollow body fillable with cleaning fluid, and having a contact surface configured for resting on a transport surface of the conveyor belt;
g) the wall of the cleaning module being perforated in a region of its contact surface, and through which a cleaning fluid exits, in use; and
h) one of the reverse vending machine and the cleaning module including a stop configured for stopping the cleaning module in a substantially stationary position on the conveyor belt when the conveyor belt is moving.

2. Reverse vending machine according to claim 1, wherein:
a) the stop includes one of a mechanical, electromechanical, and an electromagnetic stop.

3. Reverse vending machine according to claim 1, wherein:
a) the stop includes a stop bolt attached to the cleaning module and a stop element provided on the cleaning device.

4. Reverse vending machine according to claim 1, wherein:
a) an electromagnet is arranged at a stop position of the cleaning module underneath the conveyor belt, and a magnetic body is provided on the cleaning module.

5. Reverse vending machine according to claim 1, wherein:
a) at least one contact surface of the cleaning module is configured to mate with a shape of the transport surface of the conveyor belt.

6. Reverse vending machine according to claim 1, wherein:
a) a coating of at least one contact surface of the cleaning module is provided on the exterior with a surface for receiving the cleaning fluid and providing the fluid to the transport surface of the conveyor belt.

7. Reverse vending machine according to claim 6, wherein:
a) the coating of the at least one contact surface of the cleaning module includes one of microfiber tissue and netting.

8. Cleaning module for reverse vending machines for empties, comprising:
a) a hollow body fillable with cleaning fluid which is applicable to a transport surface of a conveyor belt, and the hollow body having at least one contact surface; and
b) a wall of the cleaning module having perforations in a region of its at least one contact surface and through which a cleaning fluid exits, in use.

9. Cleaning module according to claim 8, wherein:
a) the perforations include bores.

10. Cleaning module according to claim 9, wherein:
a) an identification characteristic in the form of one of barcode, transponders, and surface characteristics is provided.

11. Cleaning module according to claim 8, wherein:
a) a stop mechanism is provided, the stop mechanism being configured for stopping the cleaning module in a substantially stationary position on a conveyor belt, in use, when the conveyor belt is moving.

12. Cleaning module according to claim 8, wherein:
a) at least one contact surface of the cleaning module is provided, and being configured to mate with a shape of a transport surface of a conveyor belt, in use.

13. Cleaning module according to claim 12, wherein:
a) a coating is provided on the at least one contact surface of the cleaning module fillable with cleaning fluid, the coating receiving the cleaning fluid and providing the fluid to a transport surface of a conveyor belt, in use.

14. Cleaning module according to claim 13, wherein:
a) the coating of the at least one contact surface of the cleaning module includes one of microfiber tissue and netting.

15. Cleaning module according to claim 8, wherein:
a) the cleaning module includes two pieces, and is configured for being filled with cleaning fluid by a bottle, in use.

16. Cleaning module according to claim 8 wherein:
a) an integrated magnetic body is provided.

17. Method for operating a reverse vending machine for empties, comprising:
a) providing a reverse vending machine for empties, the reverse vending machine including:
i) a cleaning device;
ii) a recognition unit;
iii) an entry unit for the empties;
iv) a conveyor belt;
v) the cleaning device including a separate cleaning module which is insertable into the entry unit, and the cleaning module being conveyable through the automated device via the conveyor belt;
vi) the cleaning module including a hollow body fillable with cleaning fluid, and having a contact surface configured for resting on a transport surface of the conveyor belt;
vii) a wall of the cleaning module having perforations in a region of its contact surface, and through which a cleaning fluid exits, in use; and
viii) one of the reverse vending machine and the cleaning module including a stop configured for stopping the cleaning module in a substantially stationary position on the conveyor belt when the conveyor belt is moving;
b) filling the cleaning module with cleaning fluid;
c) inserting the cleaning module into the entry unit;
d) causing the cleaning module to be conveyed through the cleaning device via the conveyor belt;
e) causing the stop to stop the cleaning module in a substantially stationary position on the conveyor belt when the conveyor belt is moving; and
f) providing a cleaning mode, the cleaning mode including causing the cleaning fluid to exit the perforations of the wall of the cleaning module for cleaning at least the conveyor belt of the reverse vending machine for empties.

18. Method for operating a reverse vending machine according to claim 17, wherein:
a) the cleaning mode is switched on manually.

19. Method for operating a reverse vending machine according to claim 17, wherein:
a) the cleaning mode is automatically suspended, in use, when the cleaning module inserted into the reverse vending machine is recognized via a recognition unit provided on the reverse vending machine.

20. Method for operating a reverse vending machine according to claim 17, wherein:
a) after a cycling of the cleaning mode of the reverse vending machine, the cleaning module is stored vertically on an empties collection surface.
